(19) United States
(12) Patent Application Publication
(10) Pub. No.: US 2019/0356047 A1
(43) Pub. Date: Nov. 21, 2019

(54) RADIO-FREQUENCY HEATING MEDIUM

(71) Applicant: Intrepid Brands, LLC, Louisville, KY (US)

(72) Inventor: Rakesh Guduru, Weston, FL (US)

(21) Appl. No.: 16/414,074

(22) Filed: May 16, 2019

Related U.S. Application Data
(60) Provisional application No. 62/672,211, filed on May 16, 2018.

(51) Int. Cl. H01Q 1/44; G05D 23/19; A24F 47/00

(52) U.S. Cl. CPC H01Q 1/44; A24F 47/008; G05D 23/1919

(57) ABSTRACT

An atomizer assembly is provided that includes a radio-frequency heating medium. The atomizer assembly may be actuated by a control unit including a radio-frequency signal generator circuit and a power amplifier to amplify the radio-frequency signal produced by the radio-frequency signal generator circuit. The amplified radio-frequency signal may be transmitted to an atomizer to thereby heat a vaporizable substance. The atomizer assembly may further include a temperature sensor to measure the temperature of the atomizer such that temperature control logic of the control unit may adjust the amplified radio-frequency signal based on the measured temperature of the temperature sensor to maintain a desired temperature within the atomizer.

### PRIORITY

This application claims priority to U.S. Provisional Application No. 62/672,211, entitled “Radio-Frequency Heating Medium, filed on May 16, 2018, the disclosure of which is hereby incorporated by reference herein.

### TECHNICAL FIELD

The disclosure is directed to a radio-frequency heating medium that may be used as part of an electronic vaporization device, such as an e-cigarette or personal vaporizer, to vaporize certain materials.

### BACKGROUND

An electronic vaporization device may simulate the feeling of smoking by heating a substance to generate an aerosol, commonly called a “vapor”, that a user inhales. Vaporization provides an alternative to combustion for the delivery and consumption of various substances including, but not limited to liquids, i.e., “E-liquids,” waxes, gels and combinations thereof (singularly, “a vaporizable substance,” collectively, “vaporizable substances”). Non-limiting examples of components of vaporizable substances include: glycerin, propylene glycol, flavorings, nicotine, medicaments and combinations thereof. Vaporization may be accomplished using electronic vaporization devices, including, but not limited to, electronic cigarettes, electronic cigars, electronic pipes and electronic vaporizers (singularly “EVD,” collectively, “EVDs”).

While EVDs may reduce consumer exposure to toxins as compared to traditional smoking, there may be a cause for concern relating to consumer exposure to trace metal(s) through vapor inhalation. EVDs typically use resistive heating to vaporize the liquids in an atomizer by passing a high current through a conductor, such as a metallic coil (i.e., nickel, aluminum, silver, chromium, iron, Kanthal, Nichrome, platinum, etc.) to produce heat, thereby generating the vapor for inhalation. Such heat and harsh environments in the atomizer may cause the metallic coil to oxidize, degrade, volatilize, and/or corrode, contaminating the vapor with trace metal(s). Resistive heating may also be inefficient, as vaporization is limited to the region where the metallic coil is in contact with the wicking material, resulting in high energy consumption. Such a high energy consumption may require a long warm-up time for the atomizer to reach operating temperature and may also require the battery of the EVD to be charged and/or replaced often.

Thus, in some instances, it may be desirable to minimize the process of oxidation, degradation, volatilization, and/or corrosion of the metallic coil of the atomizer and/or to improve efficiency of an EVD. While a variety of heating mediums have been made and used, it is believed that no one prior to the inventor has made or used an invention as described herein.

### SUMMARY

The unique solution that addresses the aforementioned problems is an atomizer assembly comprising a radio-frequency heating medium. The atomizer assembly may be actuated by a control unit comprising a radio-frequency signal generator circuit and a power amplifier configured to amplify the radio-frequency signal produced by the radio-frequency signal generator circuit. The amplified radio-frequency signal may be transmitted to an atomizer to thereby heat a vaporizable substance. The atomizer assembly may further comprise a temperature sensor positioned within or near the atomizer to measure the temperature of the atomizer such that temperature control logic of the control unit may adjust the amplified radio-frequency signal based on the measured temperature of the temperature sensor to maintain a desired temperature within the atomizer. Such a radio-frequency heating medium may improve the safety of the EVD by reducing the process of oxidation, degradation, volatilization, and/or corrosion of the atomizer to thereby limit consumer exposure to trace metals. The radio-frequency medium may also reduce the energy consumption of the EVD to shorten the amount of time for the EVD to reach operating temperature and/or to lengthen the life of the battery.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts a cross-sectional view of a typical Electronic Vaporization Device.

FIG. 2 depicts a cross-sectional view of a chamber of the EVD of FIG. 1.

FIG. 3 depicts a schematic of an atomizer assembly comprising a radio-frequency heating medium for use with the EVD of FIG. 1.

FIG. 3A depicts a schematic of the atomizer assembly of FIG. 3 without a wicking material.

FIG. 4 depicts a perspective view of another radio-frequency heating medium for use with the atomizer assembly of FIG. 3.

FIG. 4A depicts a perspective view of the radio-frequency heating medium of

FIG. 4 without a wicking material.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

All percentages, parts and ratios as used herein, are by weight of the total composition of ambient moisture-activatable surface treatment powder, unless otherwise specified. All such weights, as they pertain to listed ingredients, are based on the active level and, therefore, do not include solvents or by-products that may be included in commercially available materials, unless otherwise specified.

Numerical ranges as used herein are intended to include every number and subset of numbers within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9 and so forth.

All references to singular characteristics or limitations of the present disclosure shall include the corresponding plural characteristic or limitation and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

As used herein, the term “comprising” means that the various components, ingredients, or steps, can be conjointly employed in practicing the present invention. Accordingly, the term “comprising” encompasses the more restrictive terms “consisting essentially of” and “consisting of.”

As used herein, “trace metal” collectively refers to metal, metal alloy or combinations of metal and metal alloy that is present in a vapor in a small, but measurable amount.

As used herein, “substantially free” refers to an amount in a vapor of about 1 wt. % or less, about 0.1 wt. % or less, about 0.01 wt. % or less or 0% (i.e., completely free of), one or more trace metals.

As used herein, “chamber,” “liquid chamber,” “tank,” “liquidmizer,” “cartomizer,” “disposable pod” and “clearomizer,” are used interchangeably to mean a reservoir that contains vaporizable substance to be vaporized by an EVD.

It will be appreciated that any one or more of the teachings, expressions, versions, examples, etc. described herein may be combined with any one or more of the other teachings, expressions, versions, examples, etc. that are described herein. The following-described teachings, expressions, versions, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

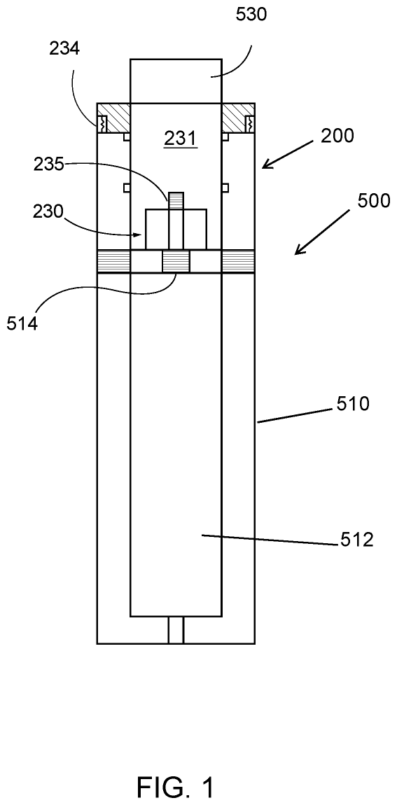

FIG. 1 shows a typical EVD 500 comprising a battery compartment 510 containing a battery 512 that is removably attached to a chamber 200 by connector 514. The chamber 200 is in turn removably attached to a mouthpiece 530. The chamber may be filled with a vaporizable substance through its open top, i.e., be a “top-filled chamber,” or it may be filled with a vaporizable substance through its open bottom, i.e., a “bottom-filled chamber.” As is known in the art, some EVDs comprise a battery compartment that is permanently affixed to a chamber of an EVD.

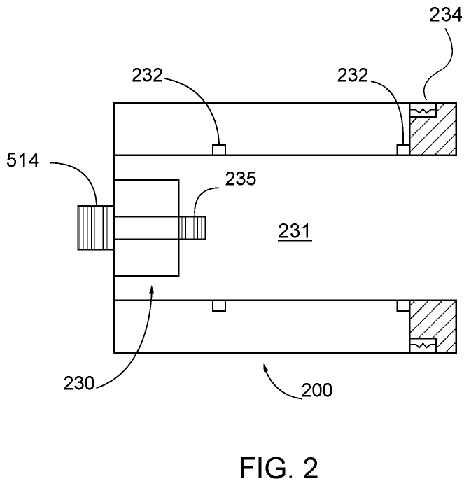

FIG. 2 shows the chamber 200 of FIG. 1 comprising an atomizer assembly 230. The atomizer assembly 230 comprises a metallic coil 235 that can be wrapped within an absorbent wick material such that the metallic coil 235 is positioned within the absorbent wick material. In some other versions, the absorbent wick material can be inserted through the metallic coil 235 such that the metallic coil 235 is positioned about the absorbent wick material. Exemplary wick material of use may be selected from cotton, nylon, porous ceramic and combinations thereof. Extending from the atomizer assembly 230 is a vapor chimney 231, which is surrounded in part by a silicone or rubber ring 232. When the chamber 200 is assembled, the atomizer assembly 230 and vapor chimney 231 fit into the chamber 200. The chamber 200 is capped at its open top by a hollow metal ring 234 that is threaded on the inside and which serves as the attachment point of the mouthpiece 530 to the chamber 200.

Accordingly, the metallic coil 235 of the atomizer assembly 230 becomes hot when supplied with electricity from the battery compartment 510 due to its resistance to the flow of electric current. The wicking material in turn acts to transport the vaporizable substance, i.e., the E-liquid, gel or melted wax, to the metallic coil 235 to heat it and release vapor. The resulting vapor may then pass through the vapor chimney 231 to be delivered to the consumer via the mouthpiece 530.

Because heat and harsh environments in the atomizer assembly 230 may cause the metallic coil 235 to oxidize, degrade, volatilize, and/or corrode, the resulting vapor may be contaminated with one or more trace metals. Further, the resistive heating medium of the atomizer assembly 230 may further have a high energy consumption because a high current is needed to reach a high temperature in the atomizer. It may thereby be desirable to provide an atomizer assembly for use with an EVD comprising a coil-free design to prevent metal contamination and/or improve the efficiency of the EVD. Accordingly, an atomizer assembly is provided comprising a radio-frequency heating medium to heat the vaporizable substance of an EVD using radio-frequency energy instead of via a typical resistive heating method with a metal coil. The radio-frequency heating medium may thereby be used in an EVD to minimize the contamination of vapor with trace metal because the radio-frequency heating medium prevents metal from being in direct contact with the vaporizable substance and/or the wicking material. The radio-frequency heating medium may also improve the efficiency of an EVD because the radio-frequency heating medium may use less energy than is typically used in a resistive heating method with a metal coil to uniformly heat the entire wicking material. This may thereby shorten the amount of time for the EVD to reach operating temperature and/or to lengthen the life of the battery.

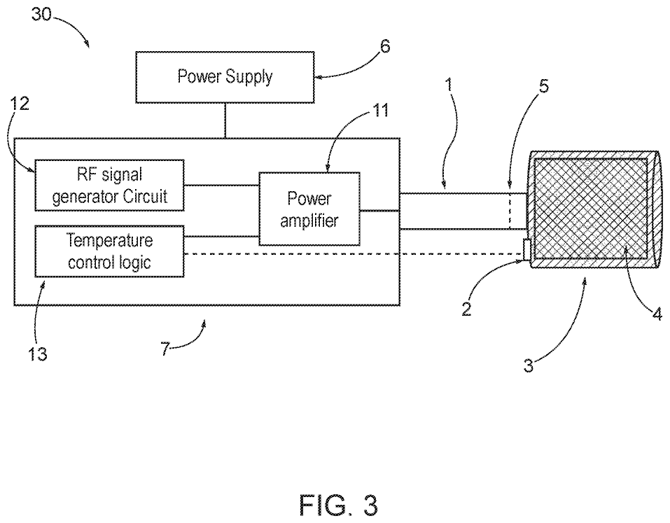

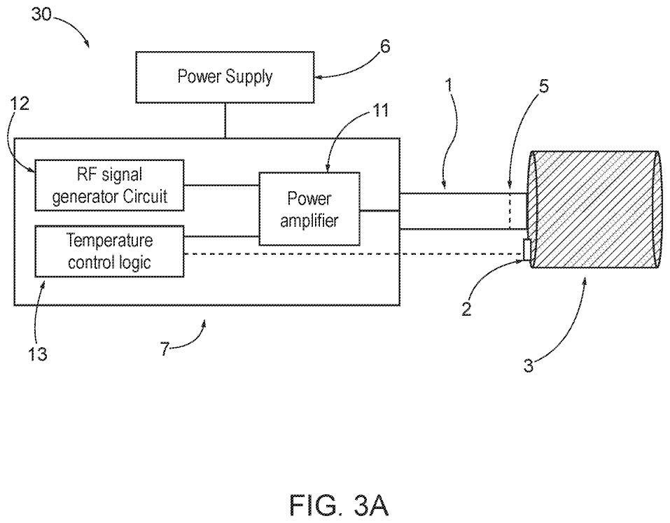

Referring to FIG. 3, an atomizer assembly 30 is shown for use with the EVD 500 instead of the resistive heating atomizer assembly 230. The atomizer assembly 30 comprises an electromagnetic or radio-frequency (RF) heating medium is shown comprising an electromagnetic or radio-frequency (RF) heating medium that may be used to vaporize a substance in an EVD. The atomizer assembly 30 comprises a power supply 6 coupled to a control unit 7, a waveguide 1, and a resonating cavity atomizer 3 containing a wicking material 4. In some other versions, the resonating cavity atomizer 3 is in direct contact with a vaporizable substance, instead of via a wicking material, as shown in FIG. 3A. The power supply 6 may provide a power of about 350 Watts, or other suitable amount, to provide power to operate the control unit 7. The power supply 6 may be the same power supply that is used to supply power to the EVD, such as the battery 512, or the power supply 6 may be a separate external power supply. Other suitable configurations for powering the atomizer assembly 30 will be apparent to one with ordinary skill in the art in view of the teachings herein.

The control unit 7 comprises an RF signal generator circuit 12, a power amplifier 11, and a temperature control logic 13. The RF signal generator circuit 12 may produce a high frequency RF signal or wave having an operating frequency region from about 3 kilohertz (kHz) to about 300 gigahertz (GHz), such as from about 915 megahertz (MHz) to about 2.4 gigahertz (GHz). The RF signal generator circuit 12 may then be coupled with the power amplifier 11 that can amplify the RF signal produced by the RF signal generator circuit 12. Such a power amplifier 11 may provide several benefits such as portability of the atomizer assembly 30 based on size and weight, a high-power gain, precise temperature control, and/or uniform heat distribution. The amplified RF signal is then transmitted to the resonating cavity atomizer 3 through a waveguide 1. The waveguide 1 may comprise a liquid-tight seal that is translucent to the electromagnetic energy in the operating frequency region.

The resonating cavity atomizer 3 shown in FIG. 3 comprises a Faraday-cage type design having a conductive metal configured to hold electromagnetic radiation inside the resonating cavity atomizer 3, while simultaneously allowing the flow of air and the vaporizable substance through the resonating atomizer cavity 3. This may confine the electromagnetic energy radiation inside the resonating cavity atomizer 3 to limit its exposure to a user. Such a resonating cavity atomizer 3 may create a standing wave, establishing an indefinite oscillation, to generate an operating temperature substantially instantaneously. Such temperatures may be from about 150° C. to about 600° C., from about 180° C. to about 300° C. or from about 150° C. to about 180° C. Further, the atomizer assembly may routinely reach a temperature of about 180° C. or about 200° C. Accordingly, limiting the standing wave to a small region, such as about 20 cm³ or other suitable volume, may substantially instantaneously heat the resonating cavity atomizer 3 to such high temperatures without requiring high power. The wicking material 4 inside resonating cavity atomizer 3 absorbs the vaporizable substance in the EVD through its capillarity. The absorbed substance may then be vaporized by heating the wicking material 4 to the boiling point of the substance through the radiation of RF energy produced by the RF heating medium of the atomizer assembly 30. The process of inhalation by the user through the mouthpiece 530 may create a continuous flow through the wicking material 4 while vaporizing the substance when heated.

The vaporizable substance may be prevented from entering the waveguide 1 and reaching the electronics in the control unit 7 by a liquid-tight material 5 positioned in an end of the waveguide 1 near the resonating cavity atomizer 3. The liquid-tight material 5 may be translucent to the RF signal at its operating frequency. The liquid-tight material 5 may comprise materials such as high-temperature resistive glass having a thickness less than a quarter wavelength of the operating frequency. Exemplary high-temperature resistive glass may be selected from silica, soda-lime silica, sodium borosilicate, lead-oxide glass, aluminosilicate, germanium oxide, and combinations thereof. Still other suitable materials will be apparent to one with ordinary skill in the art in view of the teachings herein. For instance, any material may be used that does not absorb a frequency that may increase vibrations of the RF signal during heating.

A temperature sensor 2 may be provided in or near the resonating cavity atomizer 3 that is configured to measure the temperature of the resonating cavity atomizer 3. The temperature sensor may be coupled with the control unit 7 such that the temperature control logic 13 of the control unit 7 may adjust or control the temperature of the resonating cavity atomizer 3 based on the temperature measured by the temperature sensor 2. For instance, the temperature control logic 13 may adjust the amplitude of the RF signal transmitted by the power amplifier 11 by increasing the amplitude of the RF signal to increase the temperature of the resonating cavity atomizer 3 and/or by decreasing the amplitude of the RF signal to decrease the temperature of the resonating cavity atomizer 3. Accordingly, the temperature control logic 13 may provide precise control of the amplitude of the RF signal to achieve the desired temperatures inside the resonating cavity atomizer 3. In some instances, the temperature control logic 13 can supply a maximum input signal to the power amplifier 11 to rapidly increase the temperature within the resonating cavity atomizer 3 until the desired temperature is reached. The temperature control logic 13 may then reduce the input signal to the power amplifier 11 to save energy consumption without compromising temperature.

Accordingly, the RF signal generator circuit 12 produces an RF signal with a wavelength in the desired operating frequency. The power amplifier 11 then amplifies this RF signal and the amplified RF signal is transmitted to the resonating cavity atomizer 3 via the waveguide 1. The Faraday-cage design of the resonating cavity atomizer 3 and/or the liquid-tight material 5 prevents the transmitted RF signal from returning to the control unit 7. The resonating cavity atomizer 3 creates a standing wave of RF energy to heat the wicking material 4 and/or vaporizable substance positioned within the resonating cavity atomizer 3. The vaporizable substance absorbed by the wicking material 4 is thereby vaporized and inhaled by a user through the mouthpiece of the EVD. The temperature of the resonating cavity atomizer 3 can be controlled to a desired temperature by operating the temperature control logic 13 to adjust the amplification of the RF signal transmitted by the control unit 7 through the power amplifier 11 based on the measured temperature of the resonating cavity atomizer 3 by the temperature sensor 2. This provides a coil-free design to heat the vaporizable substance while preventing metal contamination and improving efficiency. Still other suitable configurations for operating the atomizer assembly 30 will be apparent to one with ordinary skill in the art in view of the teachings herein.

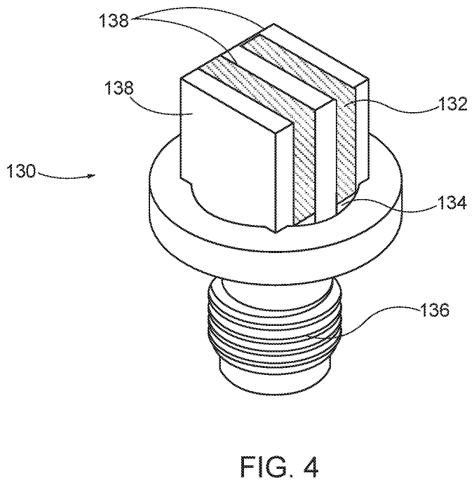

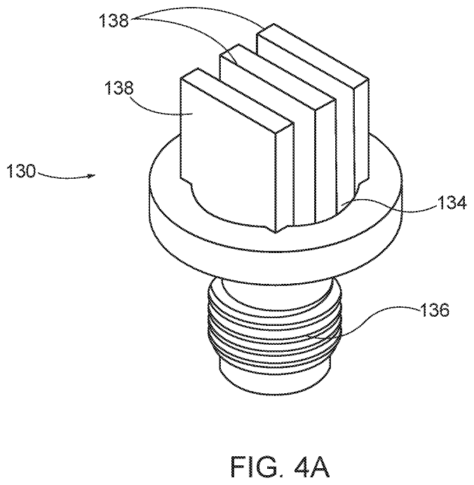

In some versions, the Faraday-cage design of the resonating cavity atomizer 3 can be modified by having a few holes in its metal frame of dimensions significantly less than the size of the wavelength of the operating frequency. In some other versions, the resonating cavity atomizer 3 can be substituted with an atomizer 130 shown in FIG. 4 comprising a wicking material 132 positioned between a plurality of electrodes 138. In some versions, the atomizer 130 does not include a wicking material, as shown in FIG. 4A, such that the atomizer 130 may be in direct contact with the vaporizable substance. Each of the electrodes 138 comprises a plate positioned substantially parallel relative to the other electrodes 138. An opening 134 is provided underneath each wicking material 132 between the electrodes 138. The electrodes 138 are then coupled with a coaxial RF connector 136, such as a subminiature version A (SMA) connector. Accordingly, the RF connector 136 may be coupled with the control unit 7 such that the amplified RF signal produced by the control unit 7 is transmitted to each of the electrodes 138 via the RF connector 136. The electrodes 138 thereby transmit the RF energy through the wicking material 132 to heat the wicking material 132 and vaporize the substance in the EVD. The vapor is thereby substantially free of trace metals, such as nickel, aluminum, silver, chromium, iron, Kanthal, Nichrome, platinum, and combinations thereof. The RF heating medium may further be more energy efficient to shorten the amount of time for the EVD to reach operating temperature and/or to lengthen the life of the battery. Of course, other suitable configurations for the atomizer assembly 30 will be apparent to one with ordinary skill in the art in view of the teachings herein.

Having shown and described various versions of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### EXAMPLE 1

An atomizer assembly for vaporizing a vaporizable substance in an electronic vaporization device comprising:
an atomizer comprising a radio-frequency heating medium in contact with a vaporizable substance; and
a control unit comprising:
   a radio-frequency signal generator configured to generate a radio-frequency signal, and
   a power amplifier coupled with the radio-frequency signal generator such that the power amplifier is configured to receive the generated radio-frequency signal from the radio-frequency signal generator and amplify the generated radio-frequency signal;

wherein the atomizer is coupled with the control unit such that the atomizer is configured to receive the amplified radio-frequency signal from the power amplifier, wherein the radio-frequency heating medium of the atomizer is configured to transmit radio-frequency energy produced by the amplified radio-frequency signal to the vaporizable substance to thereby heat the vaporizable substance.

### EXAMPLE 2

A heating element according to example 1 or any of the following examples up to example 15, wherein the radio-frequency heating medium comprises a resonating cavity chamber configured to create a standing wave of radio-frequency energy.

### EXAMPLE 3

A heating element according to example 2 or any one of the following examples up to example 15, wherein the resonating cavity chamber comprises a Faraday-cage configured to hold the radio-frequency energy within the resonating cavity chamber.

### EXAMPLE 4

A heating element according to examples 2 or 3 or any one of the following examples up to example 15, wherein the resonating cavity chamber is configured to allow air flow through the resonating cavity chamber.

### EXAMPLE 5

A heating element according to any one of the preceding examples 2, 3, and 4, or any one of the following examples up to example 15, wherein the resonating cavity chamber is coupled to the control unit via a waveguide.

### EXAMPLE 6

A heating element according to example 5, wherein the waveguide comprises a liquid-tight seal that is translucent to the amplified radio-frequency signal.

### EXAMPLE 7

A heating element according to any one of the preceding examples or following examples up to example 15, wherein the radio-frequency heating medium comprises a plurality of electrodes positioned substantially parallel with each other.

### EXAMPLE 8

A heating element according to example 7 or any one of the following examples up to example 15, wherein the plurality of electrodes is coupled to the control unit via a radio-frequency connector.

### EXAMPLE 9

A heating element according to any one of the preceding examples or following examples up to example 15, further comprising a power source configured to supply power to the control unit.

### EXAMPLE 10

A heating element according to any one of the preceding examples or following examples up to example 15, further comprising a liquid-tight material positioned between the control unit and the radio-frequency heating member, wherein the liquid-tight material is configured to prevent the vaporizable substance from contacting the control unit.

### EXAMPLE 11

A heating element according to any one of the preceding examples or following examples up to example 15, further comprising a temperature sensor configured to measure the temperature within the atomizer assembly.

### EXAMPLE 12

A heating element according to example 11 or any one of the following examples up to example 15, wherein the control unit is coupled with the temperature sensor, wherein the control unit comprises a temperature control logic configured to control the temperature within the atomizer assembly based on the measured temperature of the temperature sensor.

### EXAMPLE 13

A heating element according to example 12 or any one of the following examples up to example 15, wherein the temperature control logic is configured to control the amount of amplification provided by the power amplifier to the generated radio-frequency signal.

### EXAMPLE 14

A heating element according to example 13, wherein the temperature control logic is configured to supply a maximum input radio-frequency signal to the power amplifier until a desired temperature is reached in the atomizer assembly.

### EXAMPLE 15

A heating element according to any of the previous examples, wherein the radio-frequency medium in contact with the vaporizable substance via a wicking material.

### EXAMPLE 16

An atomizer assembly for vaporizing a vaporizable substance in an electronic vaporization device comprising a radio-frequency heating medium in contact with the vaporizable substance, wherein the radio-frequency heating medium is configured to receive a radio-frequency signal, wherein the radio-frequency heating medium is configured to transmit radio-frequency energy produced by the received radio-frequency signal to the vaporizable substance to thereby heat the vaporizable substance.

### EXAMPLE 17

A method of operating a heating element to heat a vaporizable substance, wherein the heating element comprises a radio-frequency heating medium, the method comprising the steps of:
generating a radio-frequency signal;
amplifying the radio-frequency signal;
transmitting the radio-frequency signal to the radio-frequency heating medium, wherein the radio-frequency heating medium produces heat based on the transmitted radio-frequency signal to heat the vaporizable substance.

### EXAMPLE 18

A method according to example 17 or any of the following examples, wherein the radio-frequency heating medium vaporizes a vaporizable substance, wherein the vapor is substantially free from trace metals.

### EXAMPLE 19

A method according to example 18, wherein the trace metals are selected from a group consisting of nickel, aluminum, silver, chromium, iron, Kanthal, Nichrome, platinum, and combinations thereof.

### EXAMPLE 20

A method according to any one of the preceding examples 17, 18, and 19 or any of the following examples, wherein a vaporizable substance is absorbed by a wicking material to be vaporized.

### EXAMPLE 21

A method according to any one of the preceding examples 17, 18, 19, and 20 or any of the following examples, further comprising measuring the temperature radio-frequency heating medium.

### EXAMPLE 22

A method according to example 21 or the following example, further comprising controlling the temperature of the radio-frequency heating medium based on the measured temperature.

### EXAMPLE 23

A method according to any one of the preceding examples 21 and 22, further comprising adjusting the amplification of the radio-frequency signal.

I/We claim:

1. An atomizer assembly for vaporizing a vaporizable substance in an electronic vaporization device comprising:
an atomizer comprising a radio-frequency heating medium in contact with the vaporizable substance; and
a control unit comprising:
a radio-frequency signal generator configured to generate a radio-frequency signal, and
a power amplifier coupled with the radio-frequency signal generator such that the power amplifier is configured to receive the generated radio-frequency signal from the radio-frequency signal generator and amplify the generated radio-frequency signal;
wherein the atomizer is coupled with the control unit such that the atomizer is configured to receive the amplified radio-frequency signal from the power amplifier, wherein the radio-frequency heating medium of the atomizer is configured to transmit radio-frequency energy produced by the amplified radio-frequency signal to the vaporizable substance to thereby heat the vaporizable substance.

2. The atomizer assembly of claim 1, wherein the radio-frequency heating medium comprises a resonating cavity chamber configured to create a standing wave of radio-frequency energy.

3. The atomizer assembly of claim 2 wherein the resonating cavity chamber comprises a Faraday-cage configured to hold the radio-frequency energy within the resonating cavity chamber.

4. The atomizer assembly of claim 2, wherein the resonating cavity chamber is coupled to the control unit via a waveguide.

5. The atomizer assembly of claim 4, wherein the waveguide comprises a liquid-tight seal that is translucent to the amplified radio-frequency signal.

6. The atomizer assembly of claim 1, wherein the radio-frequency heating medium comprises a plurality of electrodes positioned substantially parallel with each other.

7. The atomizer assembly of claim 6, wherein the plurality of electrodes is coupled to the control unit via a radio-frequency connector.

8. The atomizer assembly of claim 1, further comprising a power source configured to supply power to the control unit.

9. The atomizer assembly of claim 1, further comprising a liquid-tight material positioned between the control unit and the radio-frequency heating member, wherein the liquid-tight material is configured to prevent the vaporizable substance from contacting the control unit.

10. The atomizer assembly of claim 1, further comprising a temperature sensor configured to measure the temperature within the atomizer assembly.

11. The atomizer assembly of claim 10, wherein the control unit is coupled with the temperature sensor, wherein the control unit comprises a temperature control logic configured to control the temperature within the atomizer assembly based on the measured temperature of the temperature sensor.

12. The atomizer assembly of claim 11, wherein the temperature control logic is configured to control the amount of amplification provided by the power amplifier to the generated radio-frequency signal.

13. The atomizer assembly of claim 12, wherein the temperature control logic is configured to supply a maximum input radio-frequency signal to the power amplifier until a desired temperature is reached in the atomizer assembly.

14. The atomizer assembly of claim 1, wherein the radio-frequency medium is in contact with the vaporizable substance via a wicking material.

15. An atomizer assembly for vaporizing a vaporizable substance in an electronic vaporization device comprising a radio-frequency heating medium in contact with the vaporizable substance, wherein the radio-frequency heating medium is configured to receive a radio-frequency signal, wherein the radio-frequency heating medium is configured to transmit radio-frequency energy produced by the received radio-frequency signal to the vaporizable substance to thereby heat the vaporizable substance.

16. A method of operating a heating element to heat a vaporizable substance, wherein the heating element comprises a radio-frequency heating medium, the method comprising the steps of:
generating a radio-frequency signal;
amplifying the radio-frequency signal;
transmitting the radio-frequency signal to the radio-frequency heating medium, wherein the radio-frequency heating medium produces heat based on the transmitted radio-frequency signal to heat a vaporizable substance.

17. The method of claim 16, wherein the radio-frequency heating medium vaporizes the vaporizable substance, wherein the vapor is substantially free from trace metals.

18. The method of claim 18, wherein the trace metals are selected from a group consisting of nickel, aluminum, silver, chromium, iron, Kanthal, Nichrome, platinum, and combinations thereof.

19. The method of claim 16, further comprising measuring the temperature radio-frequency heating medium.

20. The method of claim 19, further comprising controlling the temperature of the radio-frequency heating medium based on the measured temperature.
